(19) United States
(12) Patent Application Publication
(10) Pub. No.: US 2019/0292794 A1
(43) Pub. Date: Sep. 26, 2019

(54) REMOVABLE FLOORING SYSTEM

(71) Applicant: Dur-A-Flex, Inc., East Hartford, CT (US)

(72) Inventors: Ming Zhao, East Longmeadow, MA (US); Kyle Sanford Smith, South Windsor, CT (US); Murty Venkata Bhamidipati, Simsbury, CT (US); Michael Joseph Schatz, Colchester, CT (US); David Royston Hughes, Fairfield, CT (US)

(21) Appl. No.: 16/362,618

(22) Filed: Mar. 23, 2019

Related U.S. Application Data
(60) Provisional application No. 62/647,742, filed on Mar. 25, 2018.

(51) Int. Cl. E04F 15/02; B32B 7/06; B32B 7/12; B32B 5/16; E04F 15/10

(52) U.S. Cl. CPC E04F 15/02155; B32B 7/06; B32B 2471/00; B32B 5/16; E04F 15/107; B32B 7/12

(57) ABSTRACT

Removable flooring, which can be peeled from a flooring substrate is prepared by applying to an adhesive layer attached to the surface of a flooring substrate a particulate material followed by application of a cross-linkable or curable polymer composition, or by applying to the adhesive layer a slurry comprising the particulate material and the cross-linkable or curable polymer composition. The cross-linkable or curable polymer composition surrounds the particulate material and adheres to the adhesive layer to provide, upon cure, a coherent, flooring layer comprising the adhesive, particular material and cured polymer which can be peeled from the underlying flooring substrate as a single substrate.

Removable flooring and methods for its preparation are provided, the removable flooring comprising 1) an adhesive layer attached to the surface of a floor or sub floor, 2) a support layer comprising particulate material and a curable polymer composition that penetrates the particulate material to form a unified, cohesive support layer that is bound to the adhesive layer such that the adhesive layer and support layer can be peeled from the floor of subflooring as one without leaving hard to remove remnants of the support layer adhered to the floor or sub floor, and optionally, 3) one or more upper polymer layers applied to the top of the support.

### BACKGROUND

Many different materials can be applied to an underlying flooring substrate, or sub-flooring, to provide a finished floor. For example, ceramic tile, vinyl tile, various laminates, linoleum and a variety of polymer coatings have been applied to a sub-flooring, which in some cases is a previously used, finished floor. Many of these are expensive or hard to remove in the event that a new floor is desired, e.g., decor change, wear or other damage, a change in how the space is used, or the need for a different set of flooring properties, such as changes to a hospital floor, the conversion of a production area to an office space or vice versa, recreational area to dining area or vice versa, etc.

There are flooring systems that are said to be readily removed from an underlying floor or sub-floor, but many such systems tend to be readily damaged, easily worn, poorly affixed to the underlying flooring substrate, and/or difficult to remove completely. Further, some sub-floors are uneven, cracked or damaged and must be cleaned, leveled or patched before the flooring is applied.

U.S. Pat. No. 5,851,618 discloses a floor coating system, usable on a variety of floor surfaces, comprising a release coating applied to a floor surface with a durable coating applied on the release coating, wherein the release coating and durable coating can be peeled away together from the floor surface when desired; or alternatively, a barrier wherein the durable coating can be peeled away from the barrier surface when desired.

US 2011/0097954 discloses a peelable coating for a surface substrate, e.g., a floor surface, comprising a base layer that is releasably peelably applied atop the surface substrate; a reinforcement layer located atop the base layer; and a bond layer applied atop the reinforcement layer for bonding through the reinforcement layer to the base layer. The base layer comprises one or more polymer resin selected from natural latex, pre-vulcanized natural latex, and high solids styrene-butadiene latex; the reinforcement layer comprises a fiberglass mesh or bio-degradable composition mesh, and the bond layer is pure acrylic, styrene acrylic, carboxylated styrene butadiene, or a polyurethane dispersion.

Use of peelable, preformed laminates, prepared from the base, reinforcement and bond layers found e.g., in US 2011/0097954, applied to a floor surface with an adhesive are known, for example, as in US 2016/0319136.

US 2015/0259544 discloses a peelable, flexible coating comprising a polymer blend of polyurethane, often as an aqueous dispersion, and at least a polymer having, in comparison to the polyurethane, a higher peel strength to the surface to be coated and a higher percent elongation at break for imparting a flexible and a peelable quality to the coating. The use of anti-skid solids in the coating is also disclosed.

Other similar systems are known, but deficiencies in many of these systems remain, e.g., cost, durability, installation or removal difficulties, and the like. There remains a need for an improved floor coating, which is durable, yet easily applied and removed.

### SUMMARY OF THE INVENTION

The present invention provides an improved removable flooring for application to a variety of underlying flooring substrates, comprising 1) an adhesion layer adhered to an underlying flooring substrate, 2) a support layer applied to the adhesion layer, and optionally, 3) one or more upper polymer layers, e.g., polymeric coating layers, wherein the adhesion, support, and optional upper polymer layers are together readily removed from the underlying flooring substrate, when desired.

As is standard in US patent practice, unless otherwise specified, “a” or “an” means one or more than one.

The support layer comprises particulate material, such as sand polymeric chips, fibers, microfibers, quartz, etc., and a curable polymer composition that penetrates the supporting material, and when cured, binds the adhesive layer and support layer into a single, cohesive layer that can be readily peeled from the underlying flooring surface. Thus, the adhesive layer is bound less strongly to the foundation layer, than to the curable polymer composition.

The particulate material can include beads, chips, spheres, microspheres, granules, fibers, microfibers, crushed fibers, aggregates, coarse or fine particulates, and the like, and may comprise synthetic or naturally according materials, for example, glass, polyester, acrylate, polyolefin, polyamide, polyurethane, polycarbonate, acrylate, acrylamides, polystyrene, styrene, polyvinyl chloride, polyacetals, copolymers, rubber, cement, sand, quartz, silica, alumina, clay, talc, metal salts, ceramics, stone, other minerals, such as metal oxides or hydroxides, etc.

A curable polymer composition in this invention comprises a polymer, prepolymer, resin, or collection of monomers that cure or crosslink by chemical reaction after applied as part of the flooring system. This is differentiated from other polymer compositions, such as dispersions or emulsions of polymers in the form of particles, oils or liquids in a carrier, e.g., an organic solvent or water, that are essentially dried without the formation of new chemical species. Often, as in the case of epoxy compositions, 1-pack polyurethanes, 2-pack polyurethanes, etc., a curable polymer composition comprises a resin or prepolymer and a curing agent, e.g., an aliphatic polyol, polyphenol, polyamine, amino-alcohol, etc. In other cases, the curable polymer composition comprises a polymer, prepolymer, resin, or collection of monomers that will react together upon initiation, e.g., by heat, light, the action of radical initiators, etc., for example, curable acrylate compositions. Hybrid systems are also known, including those that use more than one curable chemistry and those that combine curable components and nonreactive polymers, which can also be employed as curable polymer compositions. Generally, when present, such nonreactive polymers make up less than 40 wt %, e.g. less than 30, or less than 25 wt %, of the polymeric species in the cured support layer.

Typically the curable polymer composition of the invention comprises a curable resin, such as an epoxy resin, acrylate, methacrylate, acrylamide, methacrylamide, polyaspartic material, urethane or urea prepolymer, and the like, and a curative, e.g., polyol, polyphenol, polyamine, amino-alcohol, etc.; or the curable resin is a self-crosslinking polymer initiated by heat, light, radical formers, etc. For example, curable resins include one or two pack urethanes, epoxy resins, curable acrylates and the like.

Curable polymer compositions may also be used in any other layer of the layer flooring of the invention, but a curable composition must be used in preparing the support layer in order to provide the desired level of penetration of the particulate material, the bonding strength necessary for forming a strong, unified peelable support, and the physical properties needed for proper functioning of the removable flooring.

The adhesive can be almost any adhesive that binds the support layer to the underlying floor surface but not as strongly as the cured polymer composition is bound to the particulate material and adhesive.

The upper layers are adhesive or coating layers known in the art and may include curing compositions or coatings that cure essentially due to the removal of a carrier, such as the evaporation of an organic solvent or water, e.g., polyurethane or acrylate dispersions, latex or the like.

The support layer of the invention can be prepared by a process comprising distributing the particulate material on the adhesive layer and then applying a composition comprising a curable polymer to the particulate material and adhesive layer; or a composition comprising the curable polymer and the particulate matter can be prepared prior to being applied to the adhesive layer. For example, in one embodiment, a slurry comprising the curable polymer and particular material, which slurry is then applied to the adhesive layer and then the support layer is cured.

### DESCRIPTION OF THE INVENTION

The removable flooring of the invention can be applied over almost any underlying flooring substrate, or finished floor, which has sufficient cohesive strength to remain intact when the durable coating is pulled up, including sealed, polished or raw concrete or other masonry or stone, wood, metal, painted metal, asphalt, ceramic, porcelain or vinyl tile, various laminates, composites, linoleum, various plastics, polymeric floor coatings, etc., and may find use where applied over substrates used in non-flooring applications including glass, fiberglass, etc.

The support layer is applied to an adhesive layer. Typically, the adhesive layer is applied to the flooring surface as a first step in the present invention. In some circumstances, the underlying flooring substrate may need repair or reinforcement before the inventive flooring is applied. For example, cracks, holes, weak spots, loose material, lack of leveling, etc., may need to be fixed as a first step. In such situations, a sealer, primer, or foundation layer may first be employed. In some cases, there will be a pre-existing foundation layer of one or more polymeric layers already applied to the underlying flooring substrate. Such foundation layers are considered part of the underlying flooring substrate.

Formation of the peelable support comprises positioning the supporting material over the adhesive layer, applying the curable polymer composition so that the curable composition saturates the supporting material and contacts or penetrates the adhesive layer, and then curing the curable polymer composition.

The adhesive layer, which may be a pressure sensitive adhesive or other adhesive, is applied to the flooring substrate. In some embodiments a period of time will be required for curing, partial curing, drying, etc., of the adhesive before the support layer is applied.

In one embodiment, the particulate material of the support layer is applied directly to the adhesive layer after which a curable polymer composition is applied. The particulate material is penetrated and saturated evenly with the curable polymer composition, which also binds to the adhesive layer, and upon curing, strongly binds the adhesive layer, the particulate material of the support layer, and the cured polymer into a single coherent substrate, or laminate, with an even and level upper surface. The single coherent substrate will stay adhered to the underlying flooring substrate while in use, after which it can be removed and replaced if desired.

In another embodiment, the particulate material of the support layer is part of a slurry comprising that curable polymer composition, which is applied directly to the adhesive layer. The particulate material is saturated evenly with the curable polymer composition, which, as above, cures to form a coherent layer comprising the adhesive layer, the particulate material, and the cured polymer into a coherent substrate, or laminate, with an even and level upper surface.

Optional upper polymer layers can be applied to a fully cured or partially cured support layer, typically to a fully cured support layer. The upper polymer layers may comprise any flooring coating of the art, or coating system of the art, that has adequate adhesion to the support layer and the physical properties desired.

Methods for applying foundation layers, adhesion layers, and floor coating layers are known in the art and need not be further discussed here. Likewise, preparation, application and curing of the curable polymer composition of the support layer is accomplished using any applicable known method, and sizing and positioning the supporting material is well known within the skill of anyone familiar with the art.

Particles useful as the particulate material in the invention can be coarse or fine particulates, beads, chips, spheres, microspheres, granules, fibers, microfibers, crushed fibers, aggregates, comprising synthetic or naturally according materials, for example, glass, polyester, acrylate, polyolefin, polyamide, polyurethane, polycarbonate, acrylate, acrylamides, polystyrene, styrene, polyvinyl chloride, polyacetals, copolymers, rubber, cement, sand, quartz, silica, alumina, clay, talc, metal salts, ceramics, stone, other minerals, and metal based compounds such as metal oxides or hydroxides, etc.

The overall thickness of the support layer can range from 5 or 10 mil to 100 or 150 mil, e.g., from 5, 10, 15, 20 or 25 mil, to 50, 75, 100, 125 or 150 mil, or 5 to 25 mil, 25 to 50 mil, 50 to 75 or 100 mil, or 75 to 150 mil. The particulate material is sized accordingly.

Polymers other than those that cure by chemical reaction after application of the curable polymer layer may be used in the curable polymer composition, but the majority, e.g., greater than 60, 70, 75 or 80 wt %, of the polymeric elements of the curable polymer composition are materials that react during cure.

A variety of curable polymer systems may be used in the layer, for example, any curable floor coating systems, including epoxy, urethane, urea, acrylates (including methacrylate), polyaspartic, and the like, or combinations thereof, can be used, including available 1K and 2K epoxy and urethane/urea, latex (1K or 2K) systems, which may be dispersed, suspended, or dissolved in an organic solvent or water, or which may be a neat liquid, and any process for initiating curing may be employed UV curing, anionic curing, electronic beam curing, peroxide curing, LED curing, melamine cure, etc. may be used.

Certain embodiments make use of curable epoxy or urethane systems. One example of a common epoxy system comprises as epoxy resin a polymeric reaction product of bis-phenol A and epichlorohydrin, an amine or Novolac curing agent, and optionally a hardener such as a polyoxyalkylene amine, although many other usable systems are known many of which are commercially available. Polyurethane systems typically comprise an isocyanate terminated, polyol-based prepolymer and a polyol, polyamine or hydroxylamine curative. Prepolymers are often combined with the curative just before application, as in 2K systems, but 1K systems comprising a blocked prepolymer and/or a blocked curative are known, as are other 1K systems that require initiation before curing takes place. Many curable epoxy and polyurethane systems useful in the invention may also contain plasticizers, catalysts or cure accelerators.

Curable acrylate compositions can also be used in the curable polymer compositions of the peelable support, such as acrylates or methacrylates comprising pendant hydroxy or epoxy groups, those cured by radical initiation of an unsaturated bond and the like.

Curable polymer compositions such as those described above may also be used in other parts of the inventive flooring system, e.g., the foundation layer below the peelable layer, or upper layers above the peelable layer, but as stated above, a curable polymer composition in the peelable support is required in the invention.

Many other well-known adhesive, coating, and other polymer materials can be used in various layers of the present flooring. In addition to any adhesive that may be used in the peelable support, adhesives may also be used in application of the foundation layer or layers, or as one of the upper layers, for example, one may use an adhesive layer between the peelable support and other upper layers. Any adhesive with the desired adhesive properties may be used, including a variety of pressure sensitive adhesives, latex adhesives, acrylic adhesives, epoxy adhesives, adhesives applied as liquids or those applied in non-liquid form. Also, one may find in the foundation layer or upper layers, curable polymer compositions useful in the peelable support, other curable polymer compositions, coating compositions not based on curable polymers such as polyurethane dispersions, such as colloidal systems in which the polyurethane particles are dispersed in a continuous aqueous medium, coatings based on other acrylic, styrene or butadiene or copolymer chemistries, latex, pre-vulcanized natural latex, styrene-butadiene latex, polyvinyl alcohol, silicone materials, fluorinated material, etc.

Examples of curable compositions useful in the multilayer flooring system, particularly in the upper layers, include the fast curing acrylate and methacrylate coating compositions found in U.S. Pat. No. 8,669,301 and U.S. Pat. No. 9,657,191; US published application 2015/0191622 comprising a reactive acrylic based polymer comprising pendant acrylate or methacrylate groups, reactive, typically polyfunctional, unsaturated monomers, thermal or UV activated radical initiator, and optionally a tertiary amine accelerator; or US 2017/0029653 comprising a reactive polymer, oligomer or prepolymer having pendant acrylate or methacrylate groups, low odor acrylate or methacrylate monomers, an acrylate or methacrylate crosslinker, an isocyanate crosslinker, an initiator, and optionally a reactive diluent and/or bead polymer.

Coatings typically used in non-flooring applications may also be used in the inventive flooring system, for example, compositions found in copending application Ser. No. 15/366,975, two pack polyurethane coating compositions comprising a polyol, such as one or more hydroxyl functionalized acrylate or methacrylate resins, an isocyanate crosslinker, and polymeric microfibers.

Naturally a number of additives common in the art may be found in the layers and polymer compositions of the invention such as stabilizers, processing aids, rheology modifiers, colorants, fillers/reinforcing agents, and the like, for example: antioxidants, UV absorbers, HALS, catalysts, curing accelerators, curing inhibitors, hardeners, anti-static agents, flame retardants, plasticizers, dyes and pigments including effect pigments, metal flakes, opacifiers, optical brighteners, etc., thickeners, surfactants, dispersants, solvents, reactive diluents, wetting agents, detergents, tackifiers, nucleating agents, fatty acid salts, defoamers, air releasing agents, flow aids, leveling agents, matting agents, adhesion promoters, anti-slip agents, biocides, biocide, polymer chips, and granules, fibers, minifibers, microspheres, cement, sand, quartz (colored or non-colored), silica, alumina, clay, talc, metal salts CaCO3, CaSO4, BaSO4, etc., glass fibers or beads, stone chips, aggregates, lime, ceramic, rubber granules, waxes, etc.

Of course, certain additives are more likely to be used in particular layers. For example, UV absorbers are of most benefit in upper layers as are anti-slip materials, waxes and certain decorative elements, e.g., colorants selected for a particular decor, colored chips etc. Certain dyes or pigments, not essential for providing the color of the flooring may be used in underlying layers as visual guides that are useful in the application of the various layers of the flooring system.

Further, it is well known that some additives have multiple uses and may be found in different layers for different reasons and at different load levels. For example, titanium dioxide is a filler, opacifier, colorant, can have use as a UV stabilizer, etc.

In many instances, the various polymer compositions applied in installing the inventive removable coating will be allowed to dry or cure before the next material or polymer composition is applied. In some cases, however, it may be advantageous to apply the next material to a polymer composition that is not fully dried or cured. For example, greater adhesion of one polymer layer to another may be obtained by applying a subsequent polymer layer to one that is uncured or only partially cured.

One exemplary embodiment comprises applying a layer of adhesive, e.g., a latex or hybrid blend of both pre-vulcanized natural rubber latex and styrene-butadiene-rubber copolymer latex, or other pressure sensitive adhesive to a concrete floor, laying particulate matter, e.g., sand, crushed fibers, silica, etc., on the adhesive layer, applying an epoxy curing composition, or a curing composition comprising an isocyanate capped prepolymer and a curative in a manner that evenly saturates the layer of particulate material and contacts the adhesive layer and curing the curing composition, optionally applying one or more floor coating layers on the cured polymer layer.

Another exemplary embodiment comprises applying a layer of adhesive, e.g., a latex or hybrid blend of both pre-vulcanized natural rubber latex and styrene-butadiene-rubber copolymer latex, or other pressure sensitive adhesive to a concrete floor, applying to the adhesive layer a slurry of particulate material, e.g., sand, crushed fibers, silica, etc., in an epoxy curing composition, or a curing composition comprising an isocyanate capped prepolymer and a curative, curing the curing composition, and optionally applying one or more floor coating layers on the cured polymer layer.

The adhesive layer may be in any stage of cure or drying when the particulate material is laid, when the curing composition is applied, or when the slurry is applied, e.g., the adhesive may be fully cured or dried, partially cured or dried, or fully cured or dried when the particulate material is applied, when the curing composition is applied or when the slurry is applied. In many embodiments, the adhesive layer is fully cured or dried when the curing composition or slurry is applied.

There is no particular limit to the manner in which the coating layers or polymer compositions are applied, any known method compatible with the desired results may be employed. There is no particular limit to the thickness of each layer, and one skilled in in the art can readily determine the desired thickness based on what is known in the art about the chemistry and preferred application of these or similar layers. In general, the approximate thickness of a foundation, adhesive or coating layer will range from 1 to 100 mils, e.g., 1 to 50 mils, e.g., 1 or 2 to 5 or 10 mils. The number of such layers and the thickness will also be determined by the final thickness of the flooring.

When desired, the floor coating system of the present invention can be quickly removed by pulling the support/adhesion layer and the upper coating layers, up in large sheets, leaving the original underlying floor surface, upon which a new support layer and upper coating layers can be applied.

The removable flooring of the present invention may be applied to a new flooring or sub-flooring surface. In some instances, a new sub-flooring substrate, such as concrete or other masonry will already be sealed with a layer that will serve as a suitable foundation layer, and the support layer may be applied directly thereto. However, there is no prohibition against applying an additional foundation layer over an existing foundation layer.

The removable flooring of the present invention can also be applied directly over a floor which has already seen use, over a floor which has an existing coating, a floor in poor condition, etc. It is generally not necessary to remove an existing coating on a flooring surface before applying the foundation layer, but it is preferable that loose debris and excessive dirt be removed. Certain floors may contain materials, such as a wax layer, or a loosely bound temporary layer that would interfere with strong bonding of the adhesive layer and it is encouraged that such materials be removed prior to application of the flooring system of the invention.

One advantage of the present invention is that the adhesive layer/support layer and optional upper coating layers can be removed from the underlying flooring substrate and new adhesive layer/support layer and upper coating layers can be applied directly onto the underlying flooring substrate if desired.

Another advantage over the art is that there is no particular need for special preparations, such taping the perimeter of area to be coated with a UV stable adhesive tape as in US 2011/0097954. The use of a curable polymer composition in preparing the support layer also allows for stronger and more coherent removable layers than found in the art.

The removable floor coating system of the present invention as applied to a floor surface is easy to apply; is self-leveling; can use any kind of coating from very thin/low viscosity coating to self-leveling and troweling coatings; can be applied to many floor types; can be applied over floors in nearly any condition; can be easily peeled up by hand; can be easily reapplied to renew the floor surface; is readily modified to achieve any desired optical effects, e.g., color, gloss, etc., or performance characteristics such as a soft or hard floor, anti-slip floor, resistance to water, solvents, chipping, etc.; can readily provide a decorated floor containing decorative chips, quartz/stone and can be prepared using common methods and readily available materials.

What is claimed is:

1. A removable flooring comprising 1) an adhesion layer adhered to an underlying flooring substrate, 2) a support layer prepared from a composition comprising particulate material and a curable polymer composition applied to the adhesion layer, and, optionally 3) one or more upper polymer layers, wherein upon cure the curable polymer of the support layer is adhered more strongly to the adhesive layer than the adhesive layer is adhered to the underlying flooring substrate and the particulate material, cured polymer and adhesive layer can be removed from the underlying flooring substrate as a single component.

2. The removable flooring according to claim 1, wherein the particulate material comprises beads, chips, spheres, microspheres, granules, fibers, microfibers, crushed fibers, aggregates, coarse particles, fine particles, comprising glass, polyester, acrylate, polyolefin, polyamide, polyurethane, polycarbonate, acrylate, acrylamides, polystyrene, polyvinyl chloride, polyacetals, copolymers, rubber, cement, sand, quartz, silica, alumina, clay, talc, metal salts, ceramics, stone, metal oxides, or metal hydroxides.

3. The removable flooring according to claim 1, wherein the curable polymer composition of the support layer comprises an epoxy resin, acrylate, methacrylate, acrylamide, methacrylamide, polyaspartic material, urethane prepolymer, urea prepolymer, or a blocked prepolymer.

4. The removable flooring according to claim 3, wherein the curable polymer composition of the support layer further comprises a polyol, polyphenol, polyamine, amino-alcohol, blocked amine curative, or polymerization initiator.

5. The removable flooring according to claim 3, wherein the curable polymer composition comprises an epoxy resin, a urethane prepolymer or a curable acrylate.

6. The removable flooring according to claim 3, wherein the curable polymer composition comprises an epoxy resin or a urethane prepolymer and a polyol, polyphenol, polyamine, amino-alcohol, or blocked amine curative.

7. The removable flooring according to claim 2, wherein the curable polymer composition of the support layer comprises an epoxy resin, acrylate, methacrylate, acrylamide, methacrylamide, polyaspartic material, urethane prepolymer, urea prepolymer, or a blocked prepolymer.

8. The removable flooring according to claim 7, wherein the curable polymer composition of the support layer further comprises a polyol, polyphenol, polyamine, amino-alcohol, blocked amine curative, or polymerization initiator.

9. The removable flooring according to claim 7, wherein the curable polymer composition comprises an epoxy resin, a urethane prepolymer or a curable acrylate.

10. The removable flooring according to claim 7, wherein the curable polymer composition comprises an epoxy resin or a urethane prepolymer and a polyol, polyphenol, polyamine, amino-alcohol, or blocked amine curative.

11. A process for preparing the removable flooring according to claim 1, comprising applying to an adhesive layer attached to an underlying flooring substrate a slurry comprising the particulate material and the curable polymer composition, and curing the curable composition.

12. A process for preparing the removable flooring according to claim 1, comprising applying to an adhesive layer attached to an underlying flooring substrate the particulate material, then applying the curable polymer composition to the particulate material and adhesive layer, and curing the curable composition.
